(19) United States
(12) Patent Application Publication
(10) Pub. No.: US 2016/0056489 A1
(43) Pub. Date: Feb. 25, 2016

(54) Secondary Battery Type Fuel Cell System

(71) Applicant: KONICA MINOLTA, INC., Tokyo (JP)

(72) Inventor: Takayuki OKANO, Chiyoda-ku, Tokyo (JP)

(21) Appl. No.: 14/779,828

(22) PCT Filed: Mar. 26, 2014
(86) PCT No.: PCT/JP2014/058502

§ 371 Date: Sep. 24, 2015

(30) Foreign Application Priority Data
Mar. 27, 2013 (JP) 2013-066466

(51) Int. Cl. H01M 8/18; H01M 8/10; H01M 8/06

(52) U.S. Cl. CPC H01M 8/186; H01M 8/065; H01M 8/1002

(57) ABSTRACT

A secondary battery type fuel cell system is equipped with a fuel generation member and a power-generation/electrolysis unit and circulates gas between the fuel generation member and the power-generation/electrolysis unit. Among a start-up mode for starting to operate a system, a normal operation mode for normally operating the system, and a stop mode for stopping the operation of the system, at least in the normal operation mode, the value of power output from the power-generation/electrolysis unit when the power-generation/electrolysis unit is generating power and/or the value of power supplied to the power-generation/electrolysis unit when the power-generation/electrolysis unit is performing electrolysis is temporally changed.

### TECHNICAL FIELD

The present invention relates to a secondary battery type fuel cell system capable of performing not only a power generation operation but also a charging operation.

### BACKGROUND ART

In a fuel cell, typically, a solid high polymer electrolyte membrane using a solid polymer ion exchange membrane, a solid oxide electrolyte membrane using an yttria-stabilized zirconia (YSZ), or the like is sandwiched from both sides between a fuel electrode (anode) and an oxidant electrode (cathode) to form one cell. Further, there are provided a fuel gas flow path for supplying a fuel gas (for example, hydrogen) to the fuel electrode and an oxidant gas flow path for supplying an oxidant gas (for example, oxygen or air) to the oxidant electrode, and the fuel gas and the oxidant gas are supplied to the fuel electrode and the oxidant electrode via these flow paths, respectively, whereby power generation is performed.

The fuel cell in principle allows electric power energy to be extracted therefrom with high efficiency and thus achieves energy saving. In addition, the fuel cell represents an environmentally-friendly power generation technology. For these reasons, the fuel cell is expected to play a key role in solving energy and environmental concerns on a global scale.

### LIST OF CITATIONS

### Patent Literature

Patent Document 1: Japanese Translation of PCT International Application Publication No. H11-501448
Patent Document 2: JP-A-2005-85088
Patent Document 3: Japanese Translation of PCT International Application Publication No. 2007-507856

### SUMMARY OF THE INVENTION

### Technical Problem

Patent Document 1 discloses a secondary battery type fuel cell system formed by combining with a solid oxide type fuel cell, a hydrogen generation member (iron) that generates hydrogen by an oxidation reaction and is regenerable by a reduction reaction. In the above-described secondary battery type fuel cell system, at the time of a power generation operation of the system, the hydrogen generation member (iron) generates hydrogen by an oxidation reaction with water, and the hydrogen thus generated at the hydrogen generation member (iron) is used for a power generation reaction of the solid oxide type fuel cell, while at the time of a charging operation of the system, the hydrogen generation member thus oxidized (iron oxide) generates water by a reduction reaction with the hydrogen, and the water thus generated at the hydrogen generation member thus oxidized (iron oxide) is used for an electrolysis reaction of the solid oxide type fuel cell. Therefore, an insufficient reaction at the hydrogen generation member (iron) ends up with the fuel cell being insufficiently supplied with a gas to be used for a reaction of the fuel cell. More specifically, for example, in a case of the time of the power generation operation of the system, an insufficient oxidation reaction at the hydrogen generation member (iron) ends up with the fuel cell being insufficiently supplied with hydrogen to be used for the reaction of the fuel cell.

Here, at the time of the power generation operation of the system, as expressed by an equation (1) below, with respect to a value of a theoretical voltage V_{TH} calculated based on a change in Gibbs free energy caused by a power generation reaction H₂+(½)O₂→H₂O at the fuel cell, an operating voltage V_{OPE} of the fuel cell is decreased by an amount of a voltage loss V_{LOSS}.

V_{OPE}=V_{TH}−V_{LOSS} (1)

A product W_{LOSS} of the voltage loss V_{LOSS} and an operating current I_{OPE} is lost not in the form of electric energy but in the form of thermal energy, and hence it follows that the larger the voltage loss V_{LOSS}, the more power generation efficiency of the system is decreased.

Here, the voltage loss V_{LOSS} at the time of the power generation operation of the system is expressed by an equation (2) below.

$$\begin{matrix}[ Equation 1 ] & \\ {V}_{LOSS} = r \cdot {I}_{OPE} + \frac{RT}{2 F} \cdot ln ( \frac{{P}_{H 2 O}}{{P}_{H 2} \cdot {P}_{O 2}^{0.5}} ) & ( 2 )\end{matrix}$$

A first term on a right-hand side of the equation (2) above is a value calculated based on a resistance component r of a circuit and the operating current I_{OPE}, and a second term on the right-hand side of the equation (2) above is a value calculated according to the Nernst equation and by using a partial pressure of each type of gas supplied to the fuel cell. R, T, and F denote a gas constant, an absolute temperature, and a Faraday constant, respectively. Further, P_{H2}, P_{H2O}, and P_{O2} denote a partial pressure of hydrogen, a partial pressure of water vapor, and a partial pressure of oxygen, respectively.

In a case where, at the time of the power generation operation of the system, an oxidation reaction at the hydrogen generation member (iron) is insufficient, while the hydrogen partial pressure P_{H2} decreases, the water vapor partial pressure P_{H2O} increases, and thus the voltage loss V_{LOSS} given by the equation (2) above becomes high, so that the power generation efficiency of the system is decreased.

Furthermore, at the time of the charging operation of the system, as expressed by an equation (3) below, with respect to a value of the theoretical voltage V_{TH} calculated based on a change in Gibbs free energy caused by an electrolysis reaction H₂O→H₂+(½)O₂ at the fuel cell, the operating voltage V_{OPE} of the fuel cell is increased by an amount of the voltage loss V_{LOSS}.

V_{OPE}=V_{TH}+V_{LOSS} (3)

The product W_{LOSS} of the voltage loss V_{LOSS} and the operating current I_{OPE} is used as electric energy that has to be inputted additionally to cause the fuel cell to perform the electrolysis reaction, and hence it follows that the larger the voltage loss V_{LOSS}, the more charging efficiency of the system is decreased.

Here, the voltage loss V_{LOSS} at the time of the charging operation of the system is expressed by an equation (4) below.

$$\begin{matrix}[ Equation 2 ] & \\ {V}_{LOSS} = r \cdot {I}_{OPE} + \frac{RT}{2 F} \cdot ln ( \frac{{P}_{H 2} \cdot {P}_{O 2}^{0.5}}{{P}_{H 2 O}} ) & ( 4 )\end{matrix}$$

A first term on a right-hand side of the equation (4) above is a value calculated based on the resistance component r of a circuit and the operating current I_{OPE}, and a second term on the right-hand side of the equation (4) above is a value calculated according to the Nernst equation and by using a partial pressure of each type of gas supplied to the fuel cell.

In a case where, at the time of the charging operation of the system, a reduction reaction at the hydrogen generation member (iron) is insufficient, while the water vapor partial pressure P_{H2O} decreases, the hydrogen partial pressure P_{H2} increases, and thus the voltage loss V_{LOSS} given by the equation (4) above becomes high, so that the charging efficiency of the system is decreased.

In Patent Document 2, in a configuration in which a power converter (inverter) performs, by using a PWM signal, power conversion of a direct current output of a fuel cell into an alternating current output, it is merely intended to improve power conversion efficiency, and the aforementioned technique for improving efficiency of a secondary battery type fuel cell system is not disclosed.

Furthermore, in Patent Document 3, it is merely explained that, in order to prevent degradation of a catalyst and so on, a fuel cell is driven intermittently at startup and at shutdown of the fuel cell, and the aforementioned technique for improving efficiency of a secondary battery type fuel cell system is not disclosed.

In view of the above-described circumstances, the present invention has as its object to provide a secondary battery type fuel cell system that achieves high efficiency.

### Solution to the Problem

In order to achieve the above-described object, a secondary battery type fuel cell system reflecting one aspect of the present invention has a configuration including a fuel generation member that generates a fuel gas by a chemical reaction and is regenerable by a reverse reaction to the chemical reaction, and a power generation electrolysis portion that has a power generation function of performing power generation by using an oxidant gas and the fuel gas supplied from the fuel generation member and an electrolysis function of performing electrolysis of a product of the reverse reaction supplied from the fuel generation member at the time of regeneration of the fuel generation member, in which a gas is caused to circulate between the fuel generation member and the power generation electrolysis portion. Among a startup mode in which an operation of the system is started, a normal operation mode in which a normal operation of the system is performed, and a shutdown mode in which the operation of the system is shut down, at least in the normal operation mode, a value of power outputted from the power generation electrolysis portion when the power generation electrolysis portion is performing the power generation and/or a value of power to be supplied to the power generation electrolysis portion when the power generation electrolysis portion is performing the electrolysis are/is made to change with time.

### Advantageous Effects of the Invention

According to the secondary battery type fuel cell system reflecting one aspect of the present invention, at least in the normal operation mode, a value of power outputted from the power generation electrolysis portion when the power generation electrolysis portion is performing power generation and/or a value of power to be supplied to the power generation electrolysis portion when the power generation electrolysis portion is performing electrolysis change(s) with time. Because of this, at least either at the time of a power generation operation of the system or at the time of a charging operation of the system, a composition ratio of a gas to be supplied to the fuel generation member varies to enhance diffusion of the gas inside the fuel generation member. Thus, at least either at the time of the power generation operation of the system or at the time of the charging operation of the system, reactivity at the fuel generation member is improved, so that supply of a gas to be used for a reaction at the power generation electrolysis portion to the power generation electrolysis portion is increased. As a result, efficiency of the secondary battery type fuel cell system is increased.

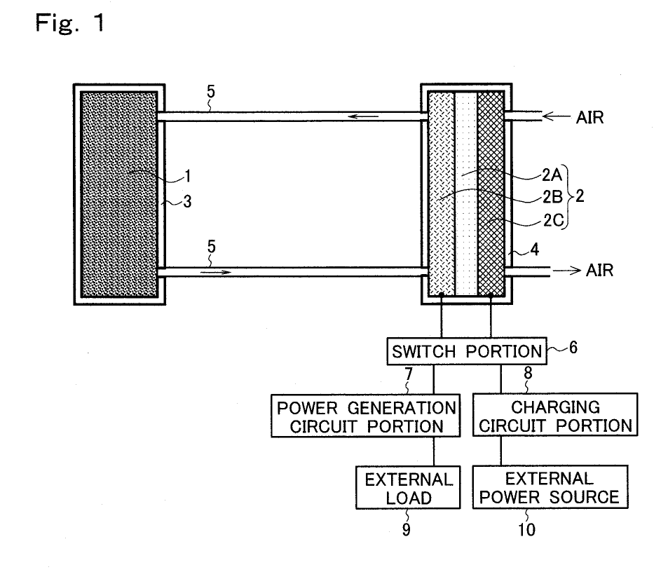

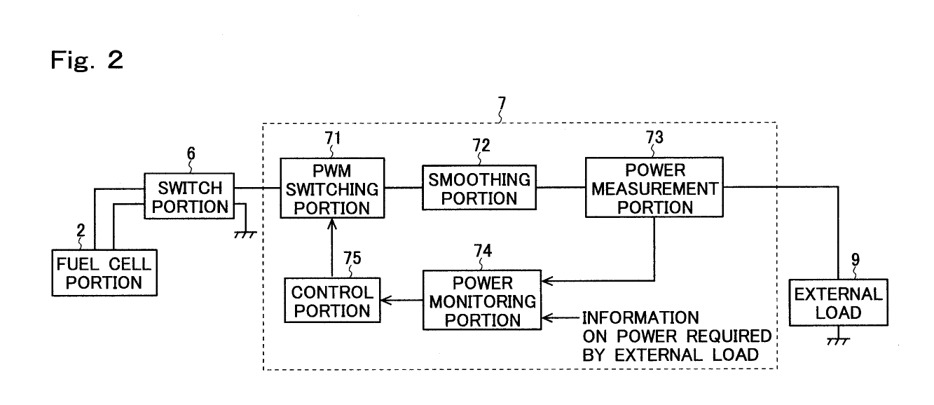

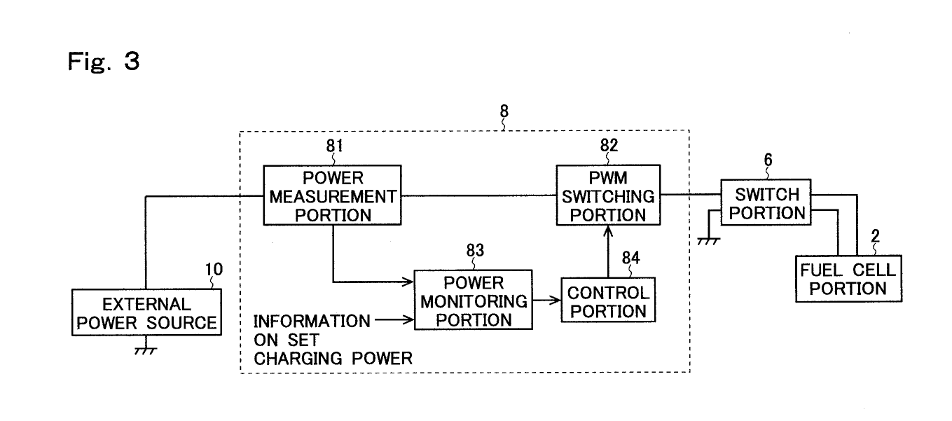

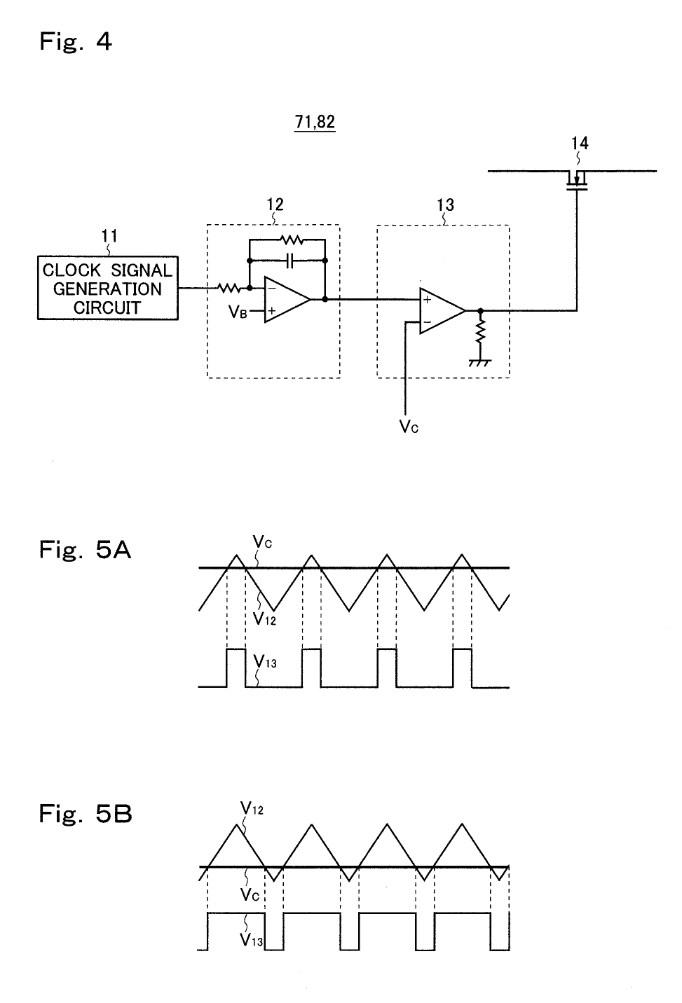

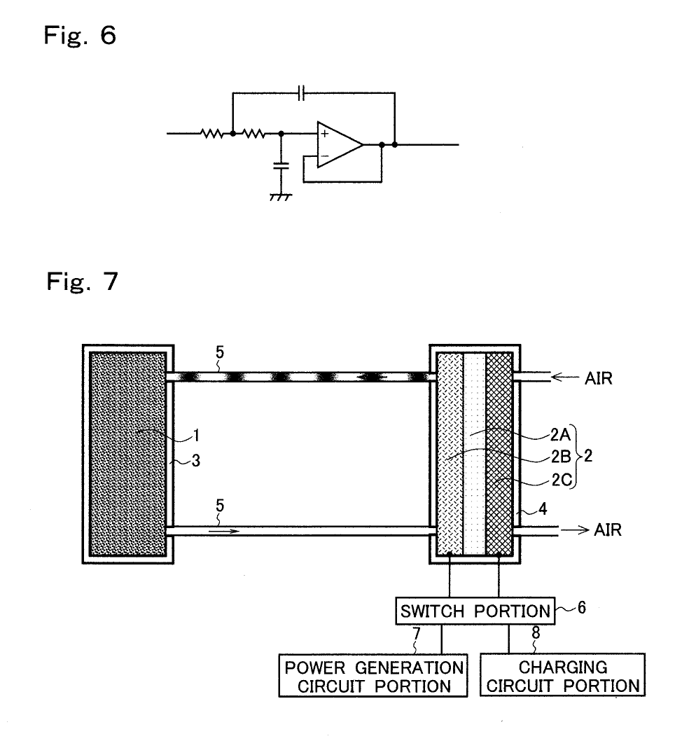

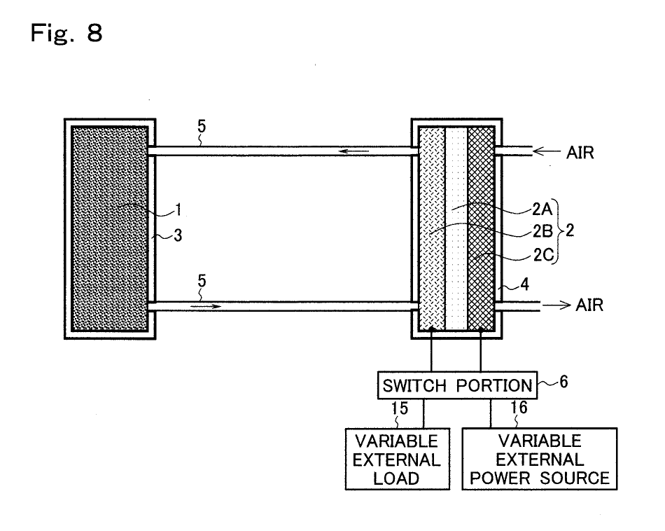

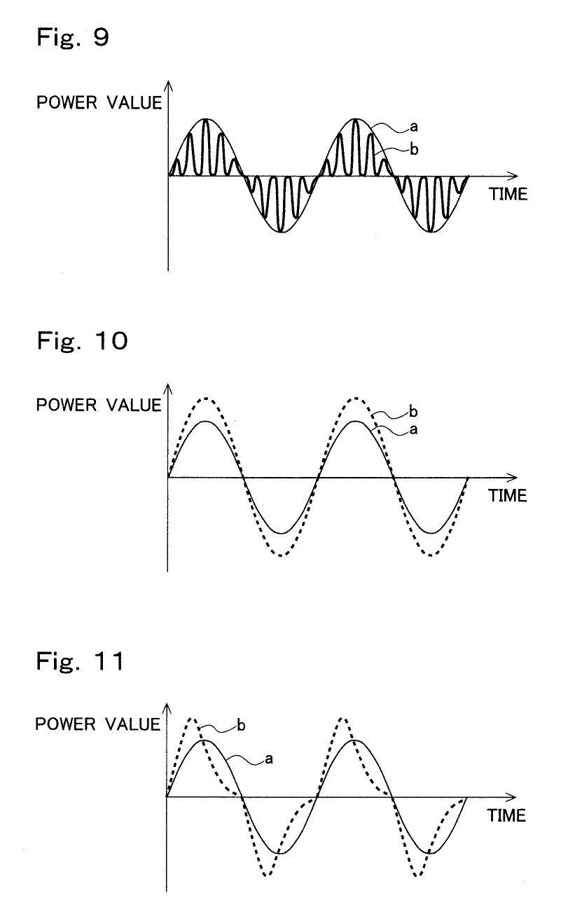

### BRIEF DESCRIPTION OF DRAWINGS

[FIG. 1] is a diagram showing a schematic configuration of a secondary battery type fuel cell system according to a first embodiment of the present invention.

[FIG. 2] is a diagram showing one configuration example of a power generation circuit portion.

[FIG. 3] is a diagram showing one configuration example of a charging circuit portion.

[FIG. 4] is a diagram showing one configuration example of a PWM switching portion.

[FIG. 5A] is a diagram showing voltage waveforms at various parts of the PWM switching portion.

[FIG. 5B] is a diagram showing voltage waveforms at the various parts of the PWM switching portion.

[FIG. 6] is a diagram showing one configuration example of a smoothing portion.

[FIG. 7] is a diagram showing a distribution of a composition ratio of a gas directed from a fuel electrode of a fuel cell portion toward a fuel generation member.

[FIG. 8] is a diagram showing a schematic configuration of a secondary battery type fuel cell system according to a second embodiment of the present invention.

[FIG. 9] is a diagram showing cycles of a change with time of a value of output power from a fuel cell portion.

[FIG. 10] is a diagram showing cycles of a change with time of a value of the output power from the fuel cell portion.

[FIG. 11] is a diagram showing cycles of a change with time of a value of the output power from the fuel cell portion.

### DESCRIPTION OF EMBODIMENTS

The following describes embodiments of the present invention with reference to the appended drawings. The present invention, however, is not limited to the after-mentioned embodiments.

### First Embodiment

FIG. 1 shows a schematic configuration of a secondary battery type fuel cell system according to a first embodiment of the present invention. The secondary battery type fuel cell system according to this embodiment includes a fuel generation member 1 that generates a fuel gas by an oxidation reaction, a fuel cell portion 2 that performs power generation by a reaction between an oxidant gas including oxygen and the fuel gas supplied from the fuel generation member 1, a housing 3 that houses the fuel generation member 1, a housing 4 that houses the fuel cell portion 2, and a duct 5 that is provided between the housing 3 and the housing 4 so that a gas circulates between the fuel generation member 1 and a fuel electrode 2B of the fuel cell portion 2.

Where necessary, a heater that adjusts a temperature, a temperature sensor that detects a temperature, and so on may be provided in vicinities of the fuel generation member 1 and the fuel cell portion 2. Furthermore, a pump, a blower, or the like for forcibly causing a gas to flow may be provided at the duct 5, a duct for supplying air as an oxidant gas to an oxidant electrode 2C of the fuel cell portion 2, and a duct for exhausting a gas from the oxidant electrode 2C of the fuel cell portion 2.

As the fuel generation member 1, there can be used, for example, a fuel generation member formed of a particulate compacted body whose base material (main component) is iron. Furthermore, as the fuel cell portion 2, there can be used, for example, a solid oxide fuel cell portion having a MEA (membrane electrode assembly) structure in which a fuel electrode and an oxidant electrode are formed on both sides of a solid electrolyte that allows O²⁻ to permeate therethrough. Although FIG. 1 shows a structure in which only one MEA is provided, there may also be provided a plurality of MEAs or a layered structure of a plurality of MEAs.

The following description is directed to a case where a fuel generation member formed of a particulate compacted body whose base material (main component) is iron is used as the fuel generation member 1, a solid oxide fuel cell portion is used as the fuel cell portion 2, and hydrogen is used as a fuel gas.

At the time of power generation of the secondary battery type fuel cell system according to this embodiment, the fuel cell portion 2 is electrically connected to an external load 9. In the fuel cell portion 2, at the time of power generation of the secondary battery type fuel cell system according to this embodiment, a reaction expressed by an equation (5) below occurs at the fuel electrode 2B.

H₂+O²⁻→H₂O+2e⁻ (5)

Electrons generated by the reaction expressed by the equation (5) above travel through the external load 9 to reach the oxidant electrode 2C, and a reaction expressed by an expression (6) below occurs at the oxidant electrode 2C.

½O₂+2e⁻→O²⁻ (6)

Then, oxygen ions generated by the reaction expressed by the expression (6) above travel through a solid electrolyte 2A to reach the fuel electrode 2B. The above-described sequence of reactions occurs repeatedly, and this is how the fuel cell portion 2 performs a power generation operation. Furthermore, as is understood from the expression (5) above, at the time of a power generation operation of the secondary battery type fuel cell system according to this embodiment, on a fuel electrode 2B side, H₂ is consumed to generate H₂O.

Based on the equations (5) and (6) above, a reaction at the fuel cell portion 2 at the time of the power generation operation of the secondary battery type fuel cell system according to this embodiment is expressed by an equation (7) below.

H₂+(½)O₂→H₂O (7)

On the other hand, at the time of power generation of the secondary battery type fuel cell system according to this embodiment, by an oxidation reaction expressed by an equation (8) below, the fuel generation member 1 consumes H₂O generated on the fuel electrode 2B side of the fuel cell portion 2 to generate H₂.

3Fe+4H₂O→Fe₃O₄+4H₂ (8)

As the oxidation reaction of iron expressed by the equation (8) above progresses, transformation of the iron into an iron oxide progresses to decrease a remaining amount of the iron. The fuel generation member 1, however, can be regenerated by a reverse reaction (reduction reaction) to the equation (8) above, and thus the secondary battery type fuel cell system according to this embodiment can be charged.

At the time of charging of the secondary battery type fuel cell system according to this embodiment, the fuel cell portion 2 is connected to an external power source 10. In the fuel cell portion 2, at the time of charging of the secondary battery type fuel cell system according to this embodiment, an electrolysis reaction expressed by an equation (9) below occurs, which is a reverse reaction to the equation (7) above, so that on the fuel electrode 2B side, H₂O is consumed to generate H₂, while at the fuel generation member 1, a reduction reaction expressed by an equation (10) below occurs, which is a reverse reaction to the oxidation reaction expressed by the equation (8) above, so that H₂ generated on the fuel electrode 2B side of the fuel cell portion 2 is consumed to generate H₂O.

H₂O→H₂+(½)O₂ (9)

Fe₃O₄+4H₂→3Fe+4H₂O (10)

The secondary battery type fuel cell system according to this embodiment also includes a switch portion 6, a power generation circuit portion 7, and a charging circuit portion 8. At the time of the power generation operation of the system, the switch portion 6 electrically connects the fuel cell portion 2 to the power generation circuit portion 7, and at the time of a charging operation of the system, it electrically connects the fuel cell portion 2 to the charging circuit portion 8.

At the time of the power generation operation of the system, the power generation circuit portion 7 makes a value of power outputted from the fuel cell portion 2 change with time between values larger and smaller than power required by the external load 9.

Here, FIG. 2 shows one configuration example of the power generation circuit portion 7. In the configuration example shown in FIG. 2, a power generation circuit portion 7 includes a PWM (pulse width modulation) switching portion 71, a smoothing portion 72, a power measurement portion 73, a power monitoring portion 74, and a control portion 75.

Based on an instruction from the control portion 75, the PWM switching portion 71 outputs PWM power to the smoothing portion 72. Accordingly, output power of a fuel cell portion 2 connected on an input side of the PWM switching portion 71 also is PWM power.

The smoothing portion 72, by smoothing the PWM power outputted from the PWM switching portion 71, converts the PWM power into direct current power and supplies the direct current power to an external load 9.

The power measurement portion 73 measures a value of the direct current power being supplied from the smoothing portion 72 to the external load 9 and transmits a result of the measurement to the power monitoring portion 74. As the result of the measurement, the power measurement portion 73 may transmit to the power monitoring portion 74, respective values of a direct current and a direct current voltage being supplied from the smoothing portion 72 to the external load 9.

The power monitoring portion 74 compares the value of the direct current power being supplied from the smoothing portion 72 to the external load 9 with a value of power required by the external load 9 and, according to a result of the comparison, adjusts a duty ratio in PWM control. There is no particular limitation on how the power monitoring portion 74 acquires information on the value of power required by the external load 9. For example, in one possible configuration, the external load 9 transmits the said information to the power monitoring portion 74, and in another possible configuration, the power required by the external load 9 always has a constant value, and the power monitoring portion 74 prestores the value of the power required by the external load 9.

At the time of the charging operation of the system, the charging circuit portion 8 converts direct current power supplied from the external power source 10 into power whose value changes with time and supplies the power to the fuel cell portion 2.

Here, FIG. 3 shows one configuration example of the charging circuit portion 8. In the configuration example shown in FIG. 3, a charging circuit portion 8 includes a power measurement portion 81, a PWM switching portion 82, a power monitoring portion 83, and a control portion 84.

The power measurement portion 81 measures a value of direct current power being supplied from an external power source 10 to the PWM switching portion 82 and transmits a result of the measurement to the power monitoring portion 83. As the result of the measurement, the power measurement portion 81 may transmit to the power monitoring portion 83, respective values of a direct current and a direct current voltage being supplied from the external power source 10 to the PWM switching portion 82.

Based on an instruction from the control portion 84, the PWM switching portion 82 converts the direct current power from the external power source 10 into PWM power and outputs the PWM power. Consequently, power to be supplied to a fuel cell portion 2 connected on an output side of the PWM switching portion 82 is PWM power.

The power monitoring portion 83 compares the value of the direct current power being supplied from the external power source 10 to the PWM switching portion 82 with a value of charging power that has been set and, according to a result of the comparison, adjusts a duty ratio in PWM control. There is no particular limitation on how the power monitoring portion 83 acquires information on the value of charging power that has been set. For example, in one possible configuration, the external power source 10 transmits information on its own power supply capability to the power monitoring portion 83, and based on the information transmitted from the external power source 10, the power monitoring portion 83 sets a value of the charging power, and in another possible configuration, the power monitoring portion 83 prestores a value of the charging power to be set at the time of the charging operation of the system.

The aforementioned PWM switching portion 71 or 82 can be configured of, for example, a circuit shown in FIG. 4. A PWM switching portion in a configuration example shown in FIG. 4 includes a clock signal generation circuit 11, an integrator circuit 12, a comparator circuit 13, and a switching element 14.

The clock signal generation circuit 11 generates a clock signal (square wave signal) having a duty ratio of 50%.

The integrator circuit 12 is a circuit composed of a resistor, a capacitor, and an operational amplifier and integrates a clock signal outputted from the clock signal generation circuit 11 to generate a triangular wave signal. A non-inverting input terminal of the operational amplifier provided in the integrator circuit 12 is supplied with a bias voltage V_{B}.

The comparator circuit 13 is a circuit composed of an operational amplifier and a resistor, compares a triangular wave signal V₁₂ outputted from the integrator circuit 12 with a control voltage V_{C} sent from the control portion 75 or 84, and outputs a PWM signal V₁₃ indicating a result of the comparison to a control terminal of the switching element 14. Accordingly, depending on a value of the control voltage V_{C}, a duty ratio of the PWM signal V₁₃ varies. By way of example, FIG. 5A shows waveforms of the triangular wave signal V₁₂, the control voltage V_{C}, and the PWM signal V₁₃ in a case where the PWM signal V₁₃ has a duty ratio of 25%, and FIG. 5B shows waveforms of the triangular wave signal V₁₂, the control voltage V_{C}, and the PWM signal V₁₃ in a case where the PWM signal V₁₃ has a duty ratio of 75%.

Furthermore, the aforementioned smoothing portion 72 can be configured of, for example, a circuit shown in FIG. 6. A smoothing portion in a configuration example shown in FIG. 6 is a low-pass filter circuit composed of a resistor, a capacitor, and an operational amplifier. For example, in a case where power outputted from the fuel cell portion 2 changes at a cycle of about several tens of Hz, when each resistor provided in the smoothing portion in the configuration example shown in FIG. 6 is set to have a resistance value of about 1 kΩ and each capacitor provided therein is set to have a capacitance of about 100 μF, it is possible to achieve an attenuation characteristic of about 30 dB at, for example, 10 Hz and thus to obtain a sufficient smoothing effect.

The secondary battery type fuel cell system according to this embodiment described thus far has a configuration in which at the time of the power generation operation of the system, a value of power outputted from the fuel cell portion 2 is made to change with time between values larger and smaller than power required by the external load 9, while at the time of the charging operation of the system, direct current power supplied from the external power source 10 is converted into power whose value changes with time, and the power is supplied to the fuel cell portion 2. Thus, at both the times of the power generation operation of the system and the charging operation of the system, there is formed a distribution shown in FIG. 7, of a composition ratio of a gas directed from the fuel electrode 2B of the fuel cell portion 2 toward the fuel generation member 1. In FIG. 7, the composition ratio of the gas flowing through the duct from the fuel cell portion 2 toward the fuel generation member 1 at a certain moment is illustrated by different degrees of shading. A densely shaded area indicates a region in which a partial pressure of hydrogen is high and a partial pressure of water vapor is low, and a less densely shaded area indicates a region in which the partial pressure of hydrogen is low and the partial pressure of water vapor is high.

Since there is formed the distribution shown in FIG. 7, the composition ratio of the gas to be supplied to the fuel generation member 1 varies to enhance diffusion of the gas inside the fuel generation member 1. More specifically, at the time of the power generation operation, when a value of PWM power outputted from the fuel cell portion 2 is a value larger than power required by the external load 9, an amount of hydrogen consumed and an amount of water vapor generated by power generation on the fuel electrode 2B side are large, so that a partial pressure of hydrogen in the gas to be sent to the fuel generation member 1 becomes lower (the less densely shaded area in FIG. 7). On the other hand, when the value of PWM power outputted from the fuel cell portion 2 is a value smaller than the power required by the external load 9, the amount of hydrogen consumed and the amount of water vapor generated on the fuel electrode 2B side are both small, so that the partial pressure of hydrogen in the gas to be sent to the fuel generation member 1 becomes higher (the densely shaded area in FIG. 7) than that when the value of PWM power outputted from the fuel cell portion 2 is a value larger than the power required by the external load 9. Furthermore, at the time of the charging operation, when a value of direct current power supplied from the external power source 10 is large, an amount of water vapor subjected to electrolysis and an amount of hydrogen generated by the electrolysis on the fuel electrode 2B side are large, so that a partial pressure of hydrogen becomes higher. On the other hand, when the value of direct current power supplied from the external power source 10 is small, the amount of water vapor decomposed and the amount of hydrogen generated on the fuel electrode 2B side are both small, so that the partial pressure of hydrogen to be supplied to the fuel generation member 1 becomes lower than that when the value of direct current power supplied from the external power source 10 is large. As described above, a mixed gas having a varying composition ratio between hydrogen and water vapor is supplied to the fuel generation member 1. This causes unevenness in gas concentrations inside the fuel generation member 1, and the gas diffuses in such a direction as to make the concentrations uniform. As a result, the gas spreads over inside the fuel generation member 1, and thus reactivity at the fuel generation member 1 is improved.

As discussed above, at both the times of the power generation operation and charging operation of the system, reactivity at the fuel generation member 1 is improved, and at the time of the power generation operation of the system, supply of hydrogen to be used for a power generation reaction at the fuel cell portion 2 to the fuel cell portion 2 is increased, while at the time of the charging operation of the system, supply of water vapor to be used for an electrolysis reaction at the fuel cell portion 2 to the fuel cell portion 2 is increased. As a result, power generation efficiency and charging efficiency of the fuel cell system are increased.

In order to increase a gas diffusion effect, a cycle at which a value of power outputted from the fuel cell portion 2 and a value of power to be supplied to the fuel cell portion 2 change with time is preferably not less than 1 Hz and less than 1 kHz and more preferably about several Hz to several hundreds of Hz. Furthermore, although in this embodiment, at the time of the power generation operation of the system, a value of power outputted from the fuel cell portion 2 is made to change with time at a short cycle between values larger and smaller than power required by the external load 9, as long as the value of power outputted from the fuel cell portion 2 is made to change with time, there is not necessarily any limitation thereto. For example, a configuration may be adopted in which the value of power is made to change within a range of values larger than the power required by the external load 9 in a certain time range and to change within a range of values smaller than the power required by the external load 9 in any other time range. In this example, when seen at a long cycle, the value of power outputted from the fuel cell portion 2 changes with time between the range of values larger than the power required by the external load 9 and the range of values smaller than that.

Furthermore, although this embodiment uses PWM control to make a value of power outputted from the fuel cell portion 2 and a value of power to be supplied to the fuel cell portion 2 change with time, any other method may be used to make the value of power outputted from the fuel cell portion 2 and the value of power to be supplied to the fuel cell portion 2 change with time.

Also in a case where, unlike in this embodiment, only either one of the following is performed: at the time of the power generation operation of the system, a value of power outputted from the fuel cell portion 2 is made to change with time between values larger and smaller than power required by the external load 9; at the time of the charging operation of the system, direct current power supplied from the external power source 10 is converted into power whose value changes with time, and the power is supplied to the fuel cell portion 2, the efficiency of the system can be increased compared with that in the conventional art.

Furthermore, in this embodiment, at all times during a time period in which the system is in operation, a value of power outputted from the fuel cell portion 2 is made to change with time between values larger and smaller than power required by the external load 9, or alternatively, direct current power supplied from the external power source 10 is converted into power whose value changes with time, and the power is supplied to the fuel cell portion 2. In fact, however, a configuration is adoptable in which, unlike in this embodiment, only in a normal operation mode in which a normal operation of the system is performed, a value of power outputted from the fuel cell portion 2 is made to change with time between values larger and smaller than power required by the external load 9, or alternatively, direct current power supplied from the external power source 10 is converted into power whose value changes with time, and the power is supplied to the fuel cell portion 2. In this configuration, in a startup mode in which an operation of the system is started and in a shutdown mode in which the operation of the system is shut down, the value of power does not necessarily have to be made to change with time. This is because, at the times of starting and shutting down the operation of the system and at the time of switching between power generation and charging, even without requiring active control, a partial pressure ratio of a gas spontaneously changes to some extent.

Furthermore, in addition to the startup mode in which the operation of the system is started, the normal operation mode in which the normal operation of the system is performed, and the shutdown mode in which the operation of the system is shut down, a direct current operation mode corresponding to a normal operation in a conventional fuel cell system may be provided. In the direct current operation mode, at the time of the power generation operation of the system, direct current power is outputted from the fuel cell portion 2, and at the time of the charging operation of the system, direct current power is supplied to the fuel cell portion 2.

### Second Embodiment

FIG. 8 shows a schematic configuration of a secondary battery type fuel cell system according to a second embodiment of the present invention. In the secondary battery type fuel cell system according to this embodiment, a power generation circuit portion 7 and a charging circuit portion 8 are not provided, and at the time of a power generation operation of the system, a switch portion 6 connects a fuel cell portion 2 to a variable external load 15, while at the time of a charging operation of the system, the switch portion 6 connects the fuel cell portion 2 to a variable external power source 16. Except for the above, the secondary battery type fuel cell system according to this embodiment has a similar configuration to that of the secondary battery type fuel cell system according to the first embodiment.

The variable external load 15 is an external load which requires power whose value changes with time and can be a load such as, for example, a fluorescent lamp or the like, which directly operates by using alternating current output power of a general commercial power source.

The variable external power source 16 is an external power source that supplies a power supply destination with power whose value changes with time and can be a natural energy power generation apparatus such as, for example, a wind power generation apparatus, a solar power generation apparatus, or the like.

The secondary battery type fuel cell system according to this embodiment provides a similar effect to that of the secondary battery type fuel cell system according to the first embodiment and can be formed by using a simplified circuit configuration compared with that of the first embodiment. That is, since the variable external load 15 requires or the variable external power source 16 supplies power whose value changes with time, according to a value of the said power whose value changes, a value of power outputted by the fuel cell portion 2 or a value of power to be supplied to the fuel cell portion 2 changes with time. As a result, a partial pressure ratio of a gas to be supplied to a fuel generation member 1 varies. Thus, in this embodiment, the PWM switching portion 71, the smoothing portion 72, and so on in the first embodiment can be omitted. As described above, although in a case where a value of power required by an external load changes with time, it seems common to adopt a configuration in which an inverter is provided between the fuel cell portion 2 and the variable external load 15, in this embodiment, there is no such need to provide an inverter, and thus a simpler circuit configuration can be used.

In a case where a cycle or an amplitude of a change with time of a value of power required by the variable external load 15 is not suitable to increase the gas diffusion effect, between the switch portion 6 and the variable external load 15, “a power conversion portion (for example, a power frequency change circuit, a power amplitude change circuit, or the like) that converts power whose value changes with time into another type of power whose value changes with time” may be provided.

Furthermore, in a case where a cycle or an amplitude of a change with time of a value of power of the variable external power source 16 to be supplied to the fuel cell portion 2 is not suitable to increase the gas diffusion effect, between the switch portion 6 and the variable external power source 16, “a power conversion portion (for example, a power frequency change circuit, a power amplitude change circuit, or the like) that converts power whose value changes with time into another type of power whose value changes with time” may be provided.

FIG. 9 shows, by taking a case of the time of power generation as an example, a cycle a of a change with time of a value of power required by the variable external load 15 and a cycle b of a change with time of a value of output power from the fuel cell portion 2 in a case where a power frequency change circuit is provided. FIG. 10 is a diagram that similarly compares a cycle a of a change with time of a value of power required by the variable external load 15 with a cycle b of a change with time of a value of output power from the fuel cell portion 2 in a case where a power amplitude change circuit is provided. Difference power between output power from the fuel cell portion 2 and power required by the variable external load 15 could be, for example, supplied to a load other than the variable external load 15 or stored in a power storage apparatus.

As described above, by providing the power conversion portion, a cycle of a change with time of a value of output power from the fuel cell portion 2 can be controlled to be at a level suitable to increase the gas diffusion effect.

When power supplied from the fuel cell portion 2 so as to be supplied to the variable external load 15 is adjusted to meet power required by the variable external load 15, due to a reason such as that a change in partial pressure ratio of a gas is shifted in time with respect to a change with time of a value of the required power or that a rate at which the change in partial pressure ratio of a gas occurs becomes more gradual than a rate at which the change with time of a value of the required power occurs, a value of actually outputted power may be shifted in time or in amount with respect to the change with time of a value of the required power. For the purpose of eliminating such a shift, a value of output power from the fuel cell portion 2 may be, for example, converted inside the circuit into such a value that each amplitude rises more quickly and largely than that of required power so that a change with time of a value of power to be supplied to the variable external load 15 at the time of power generation approximates as much as possible to a change with time of a value of the required power. FIG. 11 shows a cycle a of a change with time of a value of power required by the variable external load 15 and a change with time b of a value of output power from the fuel cell portion 2.

Furthermore, in a case where a natural energy power generation apparatus such as a wind power generation apparatus, a solar power generation apparatus, or the like is used as the variable external power source 16, a change with time of output power of the variable external power source 16 is often irregular and hard to predict. In such a case, even if the power conversion portion is provided, it may be difficult to control a cycle of a change with time of a value of output power from the fuel cell portion 2 so that it is at a level suitable to increase the gas diffusion effect. As a solution to this case, for example, the following configuration could be adopted. That is, a supply destination of output power of the variable external power source 16 is made switchable, and when a cycle and an amplitude of the output power of the variable external power source 16 are within a predetermined range, the output power of the variable external power source 16 is supplied to the fuel cell portion 2 directly or via the power conversion portion, while when at least one of the cycle and the amplitude of the output power of the variable external power source 16 deviates from the predetermined range, the output power of the variable external power source 16 is supplied to a load or a power storage apparatus other than the fuel cell portion 2. In a case where at least one of a cycle and an amplitude of an output voltage of the variable external power source 16 deviates from the predetermined range, depending on an amount of the deviation, a magnitude of power to be supplied to the fuel cell or timing at which the power is supplied thereto may be adjusted as appropriate.

### Other Embodiments

In the aforementioned embodiments, a solid oxide electrolyte is used as the solid electrolyte 2A of the fuel cell portion 2 so that, during power generation, water is generated on the fuel electrode 2B side. According to this configuration, since water is generated on a side on which the fuel generation member 1 is provided, there is an advantage in terms of achieving a simplified and miniaturized configuration of the apparatus. Meanwhile, it is also possible, as in a fuel cell disclosed in JP-A-2009-99491, to use a solid high polymer electrolyte that allows hydrogen ions to permeate therethrough is used as the solid electrolyte 2A of the fuel cell portion 2. In this case, however, during power generation, water is generated on an oxidant electrode 2C side of the fuel cell portion 2, in which case a flow path for conveying the water to the fuel generation portion 1 could be provided.

Furthermore, although in the aforementioned embodiments, the single fuel cell portion 2 performs both of power generation and water electrolysis, a configuration also may be adopted in which a fuel cell (for example, a solid oxide fuel cell dedicated to power generation) and a water electrolyzer (for example, a solid oxide fuel cell dedicated to water electrolysis) are connected in parallel on a gas flow path with respect to the fuel generation member 1.

Furthermore, although in the aforementioned embodiments, hydrogen is used as a fuel gas for the fuel cell portion 2, a reducing gas other than hydrogen such as carbon monoxide, hydrocarbon, or the like may be used as the fuel gas for the fuel cell portion 2.

Furthermore, although in the aforementioned embodiments, the fuel generation member 1 and the fuel cell portion 2 are housed in separate housings, they may be housed in a common housing. Moreover, the fuel generation member 1 and the fuel cell portion 2 may be provided so that, instead of being spaced therebetween, the fuel generation member 1 is in contact with the fuel electrode 2B of the fuel cell portion 2. This is because, also in this case, there occurs diffusion of a gas when the gas is flowing into the fuel generation member 1.

Furthermore, the aforementioned embodiments may be implemented partially in combination as appropriate as long as there is no contradiction. For example, in a possible configuration, the charging circuit 8 is removed from the secondary battery type fuel cell system according to the first embodiment of the present invention, and the switch portion 6 is connected to the variable external power source 16. Furthermore, the modified examples described in the aforementioned embodiments may be applied to any other embodiment as long as there is no contradiction.

### LIST OF REFERENCE SYMBOLS

1 fuel generation member

2 fuel cell portion

2A solid electrolyte

2B fuel electrode

2C oxidant electrode

3, 4 housing

5 duct

6 switch portion

7 power generation circuit portion

8 charging circuit portion

9 external load

10 external power source

11 clock signal generation circuit

12 integrator circuit

13 comparator circuit

14 switching element

15 variable external load

16 variable external power source

71, 82 PWM switching portion

72 smoothing portion

73, 81 power measurement portion

74, 83 power monitoring portion

75, 84 control portion

1. A secondary battery type fuel cell system, comprising:
a fuel generation member that generates a fuel gas by a chemical reaction and is regenerable by a reverse reaction to the chemical reaction; and
a power generation electrolysis portion that has a power generation function of performing power generation by using an oxidant gas and the fuel gas supplied from the fuel generation member and an electrolysis function of performing electrolysis of a product of the reverse reaction supplied from the fuel generation member at a time of regeneration of the fuel generation member,
a gas being caused to circulate between the fuel generation member and the power generation electrolysis portion,
wherein
among a startup mode in which an operation of the system is started, a normal operation mode in which a normal operation of the system is performed, and a shutdown mode in which the operation of the system is shut down, at least in the normal operation mode,
a value of power outputted from the power generation electrolysis portion when the power generation electrolysis portion is performing the power generation and/or a value of power to be supplied to the power generation electrolysis portion when the power generation electrolysis portion is performing the electrolysis are/is made to change with time.

2. The secondary battery type fuel cell system according to claim 1, further comprising:
a smoothing portion that smoothes the power outputted from the power generation electrolysis portion,
wherein among the startup mode, the normal operation mode, and the shutdown mode, at least in the normal operation mode,
when the power generation electrolysis portion is performing the power generation, the value of power outputted from the power generation electrolysis portion is made to change with time between values larger and smaller than power required by an external load.

3. The secondary battery type fuel cell system according to claim 1, wherein
when the power generation electrolysis portion is performing the power generation, an external load which requires power whose value changes with time and the power generation electrolysis portion are connected to each other without a first power conversion portion that converts direct current power into power whose value changes with time being provided therebetween.

4. The secondary battery type fuel cell system according to claim 3, wherein
when the power generation electrolysis portion is performing the power generation, the external load which requires power whose value changes with time and the power generation electrolysis portion are connected to each other without a second power conversion portion that converts power whose value changes with time into another type of power whose value changes with time being provided therebetween.

5. The secondary battery type fuel cell system according to claim 1, further comprising:
a DC/Non-DC power conversion portion that converts direct current power supplied from an external power source into power whose value changes with time,
wherein among the startup mode, the normal operation mode, and the shutdown mode, at least in the normal operation mode,
when the power generation electrolysis portion is performing the electrolysis, the power outputted from the DC/Non-DC power conversion portion is supplied to the power generation electrolysis portion.

6. The secondary battery type fuel cell system according to claim 1, wherein
when the power generation electrolysis portion is performing the electrolysis, an external power source that supplies a power supply destination with power whose value changes with time and the power generation electrolysis portion are connected to each other without a Non-DC/DC power conversion portion that converts power whose value changes with time into direct current power being provided therebetween.

7. The secondary battery type fuel cell system according to claim 6, wherein
when the power generation electrolysis portion is performing the electrolysis, the external power source that supplies a power supply destination with power whose value changes with time and the power generation electrolysis portion are connected to each other without a Non-DC/Non-DC power conversion portion that converts power whose value changes with time into another type of power whose value changes with time being provided therebetween.

8. The secondary battery type fuel cell system according to claim 1, wherein
a cycle at which the value of power outputted from the power generation electrolysis portion when the power generation electrolysis portion is performing the power generation and/or the value of power to be supplied to the power generation electrolysis portion when the power generation electrolysis portion is performing the electrolysis change(s) with time is not less than 1 Hz and less than 1 kHz.
